(19) United States
(12) Patent Application Publication
(10) Pub. No.: US 2024/0251856 A1
(43) Pub. Date: Aug. 1, 2024

(54) HEATING STRUCTURE OF AEROSOL GENERATING DEVICE AND AEROSOL GENERATING DEVICE

(71) Applicant: SHENZHEN GEEKVAPE TECHNOLOGY CO., LTD., Shenzhen (CN)

(72) Inventors: Caixue LIU, Shenzhen (CN); Hechen MO, Shenzhen (CN); Shijiang CHEN, Shenzhen (CN)

(73) Assignee: SHENZHEN GEEKVAPE TECHNOLOGY CO., LTD., Shenzhen (CN)

(21) Appl. No.: 18/016,576

(22) PCT Filed: Sep. 15, 2022
(86) PCT No.: PCT/CN2022/119112

§ 371 Date: Jan. 17, 2023

(30) Foreign Application Priority Data
Aug. 9, 2021 (CN) 202110908975.4

(51) Int. Cl. A24F 40/465; A24F 40/20; H05B 6/10

(52) U.S. Cl. CPC A24F 40/465; A24F 40/20; H05B 6/108

(57) ABSTRACT

A heating structure of an aerosol generating device and an aerosol generating device, the heating structure includes a heating tube having a heating cavity for accommodating an aerosol forming substrate and configured to heat the side of the aerosol forming substrate, and an electromagnetic heater mounted at an end of the heating tube, the electromagnetic heater has a first air inlet in communication with the heating cavity and is configured to heat the air entering the aerosol forming substrate by electromagnetic heating. Since the heating structure includes the heating tube and the electromagnetic heater, the heating tube is configured to heat the side (circumferential direction) of the aerosol forming substrate, the electromagnetic heater is configured to heat the air entering the aerosol forming substrate.

### TECHNICAL FIELD

The present disclosure relates to the technical field of aerosol generating devices, in particular to a heating structure of an aerosol generating device and an aerosol generating device.

### BACKGROUND

Heat-not-burn cigarettes are an important new type of tobacco product. Instead of directly burning cigarettes, tobacco materials are heated through an external heat source to generate smoke so that smokers can achieve a physiologically satisfying smoking effect. Compared with conventional cigarettes, the heat-not-burn cigarette has no combustion process and do not produce harmful substances such as tar and carbon monoxide, which greatly reduces the harm of smoking to consumers and the surrounding population.

An aerosol-forming substrate of the heat-not-burn cigarette needs to be heated and smoked though an aerosol generating device, a heating body is mounted in the heat-not-burn cigarette, the heating body is configured to generate heat to heat the cigarette. However, in the current heat-not-burn cigarettes, the heating body only heats from a side of the cigarette, the bottom and inside of the cigarette are difficult to be roasted evenly and thoroughly, an inhalation effect is not satisfactory.

### SUMMARY

The present disclosure provides a heating structure of an aerosol generating device and an aerosol generating device, which are mainly configured to solve a problem of uneven and incomplete baking of heat-not-burn aerosol forming substrate.

According to a first aspect, a heating structure for an aerosol generating device is provided according to an embodiment, including: a heating tube having a heating cavity configured to accommodate an aerosol forming substrate, the heating tube being configured to heat a side of the aerosol forming substrate; and an electromagnetic heater mounted at an end of the heating tube, wherein the electromagnetic heater has a first air inlet in communication with the heating cavity and is configured to heat air entering the aerosol forming substrate by electromagnetic heating.

In an embodiment, one end of the heating tube is provided with a heating body, and the heating body is configured to convert electric energy into heat energy, the other end of the heating tube is provided with the electromagnetic heater.

In an embodiment, the heating tube is provided with an upper mounting cylinder and a lower mounting cylinder therein, the heating body is of a cylindrical structure, the heating body is located between the upper mounting cylinder and the lower mounting cylinder, the heating cavity is located in the heating body, the electromagnetic heater comprises an electromagnetic induction coil and an electromagnetic induction heating core, the electromagnetic induction coil is located on an outer side of the lower mounting cylinder, the electromagnetic induction heating core is located on an inner side of the lower mounting cylinder, the electromagnetic induction heating core has the first air inlet, the electromagnetic induction coil is configured to heat the electromagnetic induction heating core by electromagnetic induction.

In an embodiment, the electromagnetic induction heating core is of a cylindrical structure, and the first air inlet is distributed on a circumference of the electromagnetic induction heating core.

In an embodiment, a fixing element is provided between the heating body and the lower mounting cylinder, the fixing element is configured to fix the heating body, the electromagnetic induction coil, and the electromagnetic induction heating core, and the fixing element further has a through hole in communication with the heating cavity and the first air inlet.

In an embodiment, a limiting element is provided at an end of the lower mounting cylinder away from the fixing element, the limiting element and the fixing element limit the electromagnetic induction coil on the lower mounting cylinder, so that the electromagnetic induction coil and the electromagnetic induction heating core are radially aligned.

In an embodiment, the fixing member is connected to the upper mounting cylinder and the lower mounting cylinder respectively by a snap-fit connection.

In an embodiment, an end of the upper mounting cylinder away from the lower mounting cylinder is provided with an upper connecting cap, the upper connecting cap is mounted on an upper end of the heating tube, the upper connecting cap has a through hole connected to the heater, an end of the lower mounting cylinder away from the upper mounting cylinder is provided with a lower connecting cap, the lower connecting cap is mounted on a lower end of the heating tube, and the lower connecting cap seals the lower end of said heating tube.

In an embodiment, the lower mounting cylinder and the heating tube have aligned second air inlets.

According to a second aspect, an aerosol generating device is provided according to an embodiment, including the above-mentioned heating structure of the aerosol generating device.

According to the heating structure of the aerosol generating device and the aerosol generating device of the above-mentioned embodiments, since the heating structure includes the heating tube and the electromagnetic heater, the heating tube is configured to heat the side (circumferential direction) of the aerosol forming substrate, the electromagnetic heater is configured to heat the air entering the aerosol forming substrate, so that the heating structure can heat the side of the aerosol forming substrate, and can also heat the air entering the aerosol forming substrate, so as to achieve uniform and thorough baking of aerosol forming substrates, and have a better inhalation effect.

### BRIEF DESCRIPTION OF THE DRAWINGS

FIG. 1 is a perspective view of a heating structure in an embodiment.

FIG. 2 is an axial exploded view of the heating structure in an embodiment.

FIG. 3 is an axial exploded view of the heating structure in an embodiment.

FIG. 4 is an axial cross-sectional view of the heating structure in an embodiment.

Reference numbers are as follows:
1—heating tube, 11—second air inlet, 2—heating body, 3—electromagnetic heater, 31—electromagnetic induction coil, 32—electromagnetic induction heating core, 321—the first air inlet, 4—upper mounting cylinder, 41—upper connecting cap, 5—lower mounting cylinder, 51—lower connecting cap, 52—limiting element, 6—fixing element, 7—aerosol forming substrate.

### DETAILED DESCRIPTION OF THE EMBODIMENTS

The present disclosure will be further described in detail below through specific embodiments in conjunction with the accompanying drawings. Similar elements in different embodiments adopt associated similar numbers. In the following embodiments, many details are described for better understanding of the present disclosure. However, those skilled in the art can readily recognize that some of the features can be omitted in different situations, or can be replaced by other elements, materials, and methods. In some cases, some operations related to the present disclosure are not shown or described in the description, this is to avoid an important part of the present disclosure being overwhelmed by too many descriptions, but for those skilled in the art, it is not necessary to describe these related operations in detail, they can fully understand the related operations according to the description in the specification and the general technical knowledge in the field.

In addition, the characteristics, operations or features described in the specification can be combined in any appropriate manner to form various embodiments. At the same time, the steps or actions in the method description can also be exchanged or adjusted in a manner obvious to those skilled in the art. Therefore, various sequences in the specification and drawings are only for clearly describing a certain embodiment, and do not mean a necessary sequence, unless otherwise stated that a certain sequence must be followed.

The serial numbers assigned to components in the present disclosure, such as “first”, “second”, etc., are only configured to distinguish the described objects, and do not have any sequence or technical meaning. The “connect” and “couple” mentioned in this present disclosure include direct and indirect connection (coupling) unless otherwise specified. The upper and lower positions in the present disclosure are described as a relationship between the upper and lower positions in the figure, and the actual product has no distinction between upper and lower.

### Embodiment 1

This embodiment provides a heating structure of an aerosol generating device. A heating body in this embodiment is a heat source, which is configured to heat and bake a heat-not-burn aerosol forming substrate, the aerosol forming substrate is a heat-not-burn cigarette. The heating body in this embodiment can simultaneously or sequentially heat a side of the heat-not-burn aerosol forming substrate and air entering the aerosol forming substrate, and can evenly and thoroughly bake the aerosol forming substrate, and has a better inhalation effect.

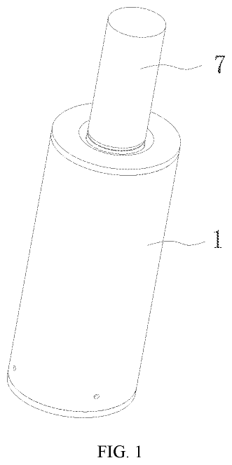

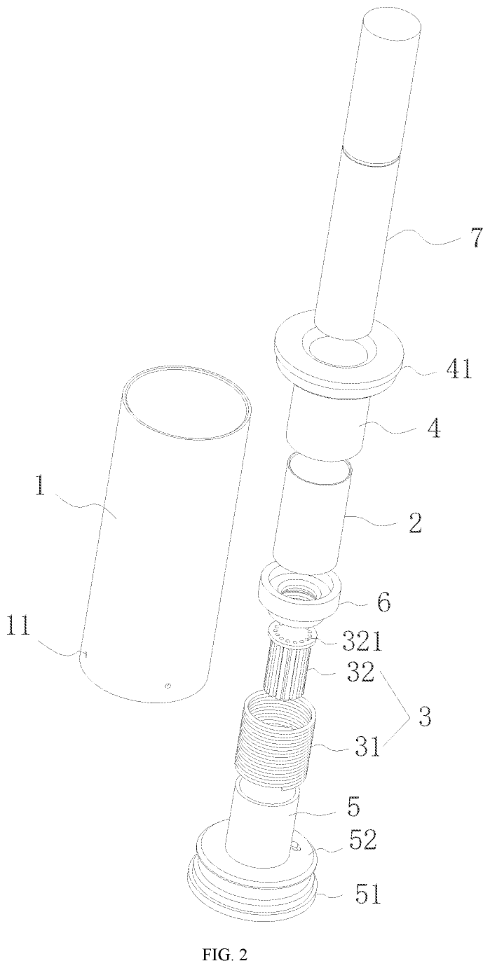

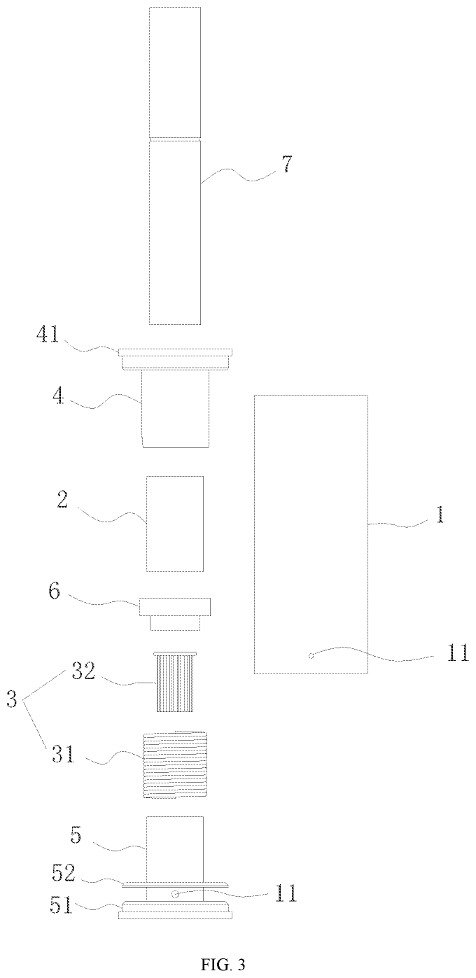

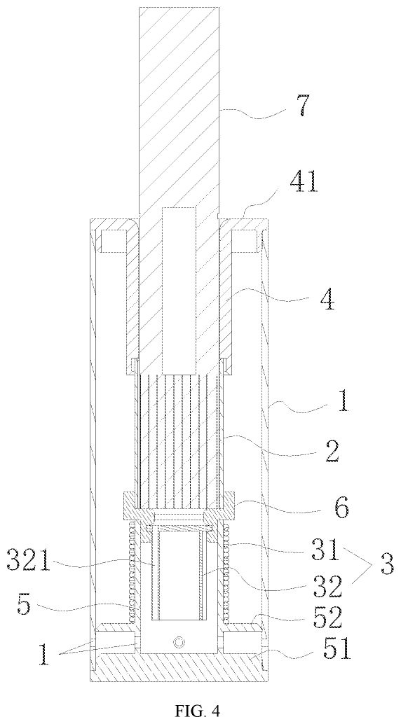

Referring to FIG. 1 to FIG. 4, the heating structure of the aerosol generating device of this embodiment mainly includes a heating tube 1, a heating body 2, and an electromagnetic heater 3.

The heating tube 1 is of a hollow cylindrical structure. An upper mounting cylinder 4 and a lower mounting cylinder 5 are mounted in the heating tube 1. The upper mounting cylinder 4 and the lower mounting cylinder 5 are respectively mounted at an upper end and a lower end of the heating tube 1. A heating cavity is formed in the upper mounting cylinder 4. The heating body 2 is of a cylindrical structure, the heating body 2 is mounted between the upper mounting cylinder 4 and the lower mounting cylinder 5. A cavity in the heating body 2 is the heating cavity. The heating body can be made of existing known heating materials. For example, the heating body 2 is a contact-type resistance heating. The heating body 2 is configured to convert electrical energy into heat energy. The heating body 2 is configured to directly contact aerosol forming substrate 7 (cigarette), and heat a circumference of the heat-not-burn aerosol forming substrate.

The heating tube 1, the upper mounting cylinder 4, and the lower mounting cylinder 5 are all made of PEEK. The heating tube 1 and the upper mounting cylinder 4, or the heating tube 1 and the lower mounting cylinder 5 are of an integrated structure. A mounting of the heating body 2 and the electromagnetic heater 3 can also be achieved by disassembling one of the upper mounting cylinder 4 and the lower mounting cylinder 5.

In other embodiments, the upper mounting cylinder 4 and the heating body 2 are of an integrated structure, and the heating body 2 is located in an interior of the upper mounting cylinder 4, which can also play a role of circumferential heating.

In this embodiment, an upper end of the upper mounting cylinder 4 has an upper connecting cap 41. The upper connecting cap 41 has a through hole in communication with the heating cavity. The upper connecting cap 41 is adapted to an upper end of the heating tube 1. The upper connecting cap 41 is mounted on the upper end of the heating tube 1, and the upper connecting cap 41 fixes the upper mounting cylinder 4 on the upper end of the heating tube 1. Similarly, a lower end of the lower mounting cylinder 5 is provided with a lower connecting cap 51, which is adapted to a lower end of the heating tube 1. The lower connecting cap 51 is mounted on the lower end of the heating tube 1, and the lower connecting cap 51 fixes the lower mounting cylinder 5 on the lower end of the heating tube lower connecting cap 51. The lower connecting cap 51 does not have a through hole, the lower connecting cap 51 is configured to seal the lower end of the heating tube 1.

In other embodiments, the upper and lower ends of the heating tube 1 are provided with protruding connecting structures, and the upper mounting cylinder 4 and the lower mounting cylinder 5 can also be fixed to the upper and lower ends of the heating tube 1, respectively.

In this embodiment, the electromagnetic heater 3 includes an electromagnetic induction coil 31 and an electromagnetic induction heating core 32. An inner diameter of the electromagnetic induction coil 31 is greater than an outer diameter of the lower mounting cylinder 5, and the electromagnetic induction coil 31 is sleeved on an outer side of the lower mounting cylinder 5. The electromagnetic induction heating core 32 is of a cylindrical structure, and one end thereof is closed. An outer diameter of the electromagnetic induction heating core 32 is less than an inner diameter of the lower mounting cylinder 5. The electromagnetic induction heating core 32 is mounted in the lower mounting cylinder 5. The electromagnetic induction heating core 32 is made of metal, when the electromagnetic induction coil 31 is energized, the electromagnetic induction coil 31 heats the electromagnetic induction heating core 32 through a principle of electromagnetic induction. The electromagnetic induction heating core 32 is circumferentially provided with a plurality of evenly distributed first air inlets 321. The first air inlets 321 are in communication with the heating cavity, the electromagnetic induction heating core 32 can heat the air in the first air inlet 321, and then heat the interior of the aerosol forming substrate 7 by the air entering the aerosol forming substrate 7.

A lower end of the lower mounting cylinder 5 and the lower end of the heating tube 1 are provided with aligned second air inlets 11, which are configured to guide the air into the first air inlet 321 for heating, so as to achieve airflow communication. The second air inlet 11 can also be directly provided on an end surface of the lower connecting cap 51, and can also play a role of airflow communication.

In this embodiment, a middle portion in the heating tube 1 is further provided with a fixing element 6. The fixing element 6 is of an annular structure and is located between the heating body 2 and the lower mounting cylinder 5. The fixing element 6 has multiple functions, one of which is to limit the heating body 2 and the lower mounting cylinder 5, the other one of which is to limit the electromagnetic induction coil 31 and the electromagnetic induction heating core 32.

Specifically, an outer diameter of the upper mounting cylinder 4 is greater than that of the lower mounting cylinder 5, an inner diameter of the upper mounting cylinder 4 is the same as an inner diameter of the heating body 2. The upper mounting cylinder 4 and the heating body 2 are connected in series for inserting the aerosol forming substrate 7. The fixing element 6 is composed of a large ring structure and a small ring structure arranged axially side by side. A sinking platform facing upward is formed between the large ring structure and the small ring structure. An inner diameter of the large ring structure of the fixing element 6 is equal to or slightly less than an outer diameter of the heating body 2. A lower end of the heating body 2 is plugged into the sinking platform at the upper end of the fixing element 6. An outer diameter of the small ring structure of the fixing element 6 is equal to or slightly greater than an inner diameter of the lower mounting cylinder 5. The small ring structure of the fixing element 6 is snapped into the lower mounting cylinder 5. The fixing element 6 is connected between the heating body 2 and the lower mounting cylinder 5, so as to achieve a mutual limitation between the heating body 2 and the lower mounting cylinder 5.

The small ring structure of the fixing element 6 is snapped into an inner step of the lower mounting cylinder 5, and it can also fix the electromagnetic induction heating core 32 in the lower mounting cylinder 5. The small ring structure of the fixing element 6 has an engaging groove, an upper end of the electromagnetic induction heating core 32 has a radially protruding buckle, the buckle is connected to the engaging groove, so that the electromagnetic induction heating core 32 is fixed to the fixing element 6, and the electromagnetic induction heating core 32 is suspended in the lower mounting cylinder 5. The heat of the electromagnetic induction heating core 32 can be transferred through the fixing element 6. The electromagnetic induction heating core 32 and the fixing element 6 can also be fixed by threaded connection, etc. to fix the aerosol forming substrate 7 or the heating body 2. An outer diameter of the large ring structure of the fixing element 6 is greater than the outer diameter of the lower mounting cylinder 5, so that the fixing element 6 can be configured to limit the electromagnetic induction coil 31. The lower end of the lower mounting cylinder 5 is further provided with a limiting element 52. The limiting element 52 is a limiting ring, or the limiting element 52 can also be several radially protruding limiting blocks. The limiting element 52 and the large ring structure of the fixing element 6 limit and fix the electromagnetic induction coil 31 on the lower mounting cylinder 5, so that the electromagnetic induction coil 31 and the electromagnetic induction heating core 32 are radially aligned, so as to improve heating efficiency.

In this embodiment, the fixing element 6 is made of silica gel, which can also be configured to transfer the heat energy of the electromagnetic induction heating core 32 to an end of the aerosol forming substrate 7, so as to play a role of uniform baking.

In other embodiments, the fixing element 6 can also be connected to the upper mounting cylinder 4 and the lower mounting cylinder 5 through threaded connection, etc.

In other embodiments, a length of the heating tube 1 is adapted to the upper mounting cylinder 4. The lower mounting cylinder 5 is connected to an outer side of the heating cylinder 1, an outer side of the lower mounting cylinder 5 is covered by a protecting layer, which can also achieve the circumferential heating of the aerosol forming substrate 7 and the heating of the incoming air.

In this embodiment, a heating method and a heating principle of the heating structure of the aerosol generating device are as follows:

Step 1: in a preheating stage, the aerosol forming substrate 7 is circumferentially heated by the heating body 2 to ensure rapid smoke emission. However, the contact resistance heating (circumferential heating body heating) in this part is not an essential process.

Step 2: when the aerosol forming substrate 7 is inhaled for one or two puffs or is preheated for a certain period of time, the electromagnetic heater 3 at a bottom of the aerosol forming substrate 7 is turned on to heat up rapidly.

Step 3: non-contact heating air: the electromagnetic heater 3 heat, so that an outer layer of the electromagnetic induction heating core 32 is heated rapidly. After a temperature of the heating core rises up, the air in the first air inlet 321 distributed circumferentially on the electromagnetic induction heating core 32 is fully heated up.

Step 4: the electromagnetic induction has a skin effect, so that the temperature of a metal surface of the electromagnetic induction heating core 32 is relatively high. After the metal surface is heated up, the heat can be radiated and conducted to the air inside the first air inlet 321, the hot air heats the aerosol forming substrate 7 through heat conduction and convection.

In the heating structure of the aerosol generating device in this embodiment, since the heating structure includes the heating tube 1 and the electromagnetic heater 3, the heating tube 1 is configured to heat the side (circumferential direction) of the aerosol forming substrate, the electromagnetic heater 3 is configured to heat the air entering the aerosol forming substrate, so that the heating structure can heat the side of the aerosol forming substrate, and can also heat the air entering the aerosol forming substrate, so as to achieve uniform and thorough baking of aerosol forming substrates, and have a better inhalation effect.

### Embodiment 2

This embodiment provides an aerosol generating device. The aerosol generating device is a heat-not-burn device. The aerosol generating device includes a housing and the heating structure in the above embodiment, the heating structure is mounted in the housing. A power supply and wires are provided inside the housing, the power supply is connected to the heating structure through the wires. The power supply supplies power to the heating structure, the heating structure converts electric energy into heat energy to heat and bake the aerosol forming substrate.

The aerosol generating device of this embodiment adopts the heating structure of the above-mentioned embodiment, which can heat the side and bottom of the aerosol forming substrate, and heat the air entering the aerosol forming substrate, so as to achieve uniform and thorough baking of the aerosol forming substrate, and have a better inhalation effect.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. A heating structure of an aerosol generating device, comprising:
a heating tube having a heating cavity configured to accommodate an aerosol forming substrate, the heating tube being configured to heat a side of the aerosol forming substrate; and
an electromagnetic heater mounted at an end of the heating tube, wherein the electromagnetic heater has a first air inlet in communication with the heating cavity and is configured to heat air entering the aerosol forming substrate by electromagnetic heating.

2. The heating structure of the aerosol generating device according to claim 1, wherein one end of the heating tube is provided with a heating body, and the heating body is configured to convert electric energy into heat energy, the other end of the heating tube is provided with the electromagnetic heater.

3. The heating structure of the aerosol generating device according to claim 2, wherein the heating tube is provided with an upper mounting cylinder and a lower mounting cylinder therein, the heating body is of a cylindrical structure, the heating body is located between the upper mounting cylinder and the lower mounting cylinder, the heating cavity is located in the heating body, the electromagnetic heater comprises an electromagnetic induction coil and an electromagnetic induction heating core, the electromagnetic induction coil is located on an outer side of the lower mounting cylinder, the electromagnetic induction heating core is located on an inner side of the lower mounting cylinder, the electromagnetic induction heating core has the first air inlet, the electromagnetic induction coil is configured to heat the electromagnetic induction heating core by electromagnetic induction.

4. The heating structure of the aerosol generating device according to claim 3, wherein the electromagnetic induction heating core is of a cylindrical structure, and the first air inlet is distributed on a circumference of the electromagnetic induction heating core.

5. The heating structure of the aerosol generating device according to claim 3, wherein a fixing element is provided between the heating body and the lower mounting cylinder, the fixing element is configured to fix the heating body, the electromagnetic induction coil, and the electromagnetic induction heating core, and the fixing element further has a through hole in communication with the heating cavity and the first air inlet.

6. The heating structure of an aerosol generating device according to claim 5, wherein a limiting element is provided at an end of the lower mounting cylinder away from the fixing element, the limiting element and the fixing element limit the electromagnetic induction coil on the lower mounting cylinder, so that the electromagnetic induction coil and the electromagnetic induction heating core are radially aligned.

7. The heating structure of an aerosol generating device according to claim 5, wherein the fixing member is connected to the upper mounting cylinder and the lower mounting cylinder respectively by a snap-fit connection.

8. The heating structure of an aerosol generating device according to claim 3, wherein an end of the upper mounting cylinder away from the lower mounting cylinder is provided with an upper connecting cap, the upper connecting cap is mounted on an upper end of the heating tube, the upper connecting cap has a through hole connected to the heater, an end of the lower mounting cylinder away from the upper mounting cylinder is provided with a lower connecting cap, the lower connecting cap is mounted on a lower end of the heating tube, and the lower connecting cap seals the lower end of said heating tube.

9. The heating structure of an aerosol generating device according to claim 3, wherein the lower mounting cylinder and the heating tube have aligned second air inlets.

10. An aerosol generating device, comprising the heating structure of the aerosol generating device according to claim 1.
